(19) United States
(12) Patent Application Publication
(10) Pub. No.: US 2022/0258937 A1
(43) Pub. Date: Aug. 18, 2022

(54) USE OF A COMPOSITE MATERIAL AS PACKAGING MATERIAL

(71) Applicant: Carl Freudenberg KG, Weinheim (DE)

(72) Inventors: Johanna Spoerl, Stuttgart (DE); Arun Prasad Venugopal, Weinheim (DE); Klaus-Dietmar Wagner, Heddesheim (DE); Anthony Hollingsworth, Birkenau (DE); Michaela Rau, Schriesheim (DE); Alexander Kolew, Frankenstein (DE); Naotaka Kimura, Moriyamashi (JP)

(21) Appl. No.: 17/591,610

(22) Filed: Feb. 3, 2022

(30) Foreign Application Priority Data
Feb. 17, 2021 (DE) 10 2021 103 701.8

(51) Int. Cl. B65D 65/40; B32B 5/26; B32B 5/02; B65B 5/04; B65B 55/02

(52) U.S. Cl. CPC B65D 65/40; B32B 5/271; B32B 5/267; B32B 5/022; B32B 5/269; B32B 2439/80; B65B 55/02; B32B 2262/124; B32B 2262/0276; B32B 2262/0253; B32B 2307/724; B65B 5/04

(57) ABSTRACT

A packaging includes a composite material. The composite material includes a barrier layer and a backing layer. The backing layer includes a spunbonded nonwoven, arranged on at least one side of the barrier layer and bonded to the barrier layer by heat and pressure. The barrier layer includes a nonwoven containing 1 to 70 wt % melt-blown fibers and 30 to 99 wt % staple fibers, relative to a total weight of the nonwoven in each case.

### CROSS REFERENCE TO RELATED APPLICATIONS

This application claims benefit to German Patent Application No. DE 10 2021 103 701.8, filed on Feb. 17, 2021, which is hereby incorporated by reference herein.

### FIELD

The invention relates to the use of a composite material as packaging material—in particular, for sterile packaging applications. The invention further relates to packaging comprising a composite material as described herein and to a method for providing a packaged article.

### BACKGROUND

In industrial packaging applications, particularly in the technical field of medicine, there is a high demand for sterile packaging materials. Such sterile packaging materials are required for the standard packaging of various compositions and active ingredients, such as medicinal products and medical liquids, or devices, such as syringes or wound dressings. Sterile packaging materials must have a specific combination of advantageous properties. Most importantly, they must exhibit a relatively high level of stability. This is necessary because standard sterilization processes are carried out under harsh conditions, e.g., with γ-radiation, under heat or pressure, and/or in the presence of aggressive chemicals such as ethylene oxide. If a packaging material is not sufficiently stable, it will be damaged in the sterilization process, and the packaged article may be contaminated. Furthermore, a sterile packaging material should be mechanically stable in order to avoid damage and subsequent contamination during the production process, during storage, during transport, and the like. A stable packaging material should also exhibit a high level of air permeability as a prerequisite for sterilization using chemicals. However, a sterile packaging material must still exhibit a high barrier function against germs, such as bacteria or viruses. For standard applications, sterile packaging materials should also be relatively light and cost-effective.

Common packaging materials, such as paper or plastic film, are not suitable for the sterile packaging of goods, since they lack sufficient mechanical stability for the sterilization process and also lack air permeability and/or a barrier function.

Conventional nonwovens are not suitable for sterile packaging applications either. Conventional spunbonded nonwovens or staple fiber nonwovens have relatively large fiber diameters in the range of approximately 10 μm to 100 μm. The relatively thick fibers impart a high mechanical strength to the nonwovens. However, the barrier function of the nonwovens against bacteria and viruses is insufficient, since the pore sizes, which are typically greater than 15 μm, are too large.

Fine fibers having diameters in the range of approximately 0.3 μm to 5 μm can be obtained according to a conventional melt-blowing method. The pore sizes of melt-blown nonwovens are small and may constitute an efficient barrier against bacteria or viruses. However, the very fine fibers impart only a low mechanical strength to the nonwovens. Therefore, melt-blown nonwovens are generally damaged in standard sterilization methods—for example, with γ-radiation. In addition, the low mechanical strength increases the general risk of damage during production and handling, and during subsequent decontamination. Standard melt-blown nonwovens are, therefore, generally unsuitable and are not used for sterile packaging applications.

In order to overcome such known problems of spunbonded nonwovens or melt-blown nonwovens, in the technical process, various non-wovens are laminated for use as sterile packaging. Typical materials are three-layer or four-layer laminates, known as SMS (spunbond melt-blown spunbond) or SMMS materials. Various nonwoven layers can be combined and glued to one another—typically by thermal bonding with thermoplastic components. This results in sandwich-like structures, which demonstrate a barrier function due to the melt-blown layers and mechanical strength due to the spunbonded layers.

In this context, a reference product for medical sterile packaging, but also for various other applications, is commercially available under the trademark, Tyvek, from DuPont, USA. The porous sheet material is obtained from high-density polyethylene by means of a so-called “flash spinning” method.

In the “flash spinning” method, a polymer is first dissolved in a preferably low-boiling solvent under high pressure and comparatively high temperature. In this case, the solvent is not able to dissolve the polymer at temperatures below its boiling point. The polymer solution is then sprayed through a nozzle at a comparatively high pressure and comparatively high temperature into a lower pressure environment and conducted by a gas stream at high speed. In this case, the solvent evaporates very quickly, and the resulting polymer filaments are stretched. When the polymer filaments are deposited, the porous fabric is ultimately produced, consisting of a three-dimensional network of finest filaments and fibrous regions connected to one another by nodes. The material is then solidified by calendering with smooth rollers or with engraving rollers. The porous fabric produced by means of “flash spinning” methods differs structurally from a conventional nonwoven and is described in, for example, US 2010/0263108 A1, US 2008/0220681 A1, or U.S. Pat. No. 6,034,008. As a solvent-based process, the production process for the porous fabric using “flash spinning” can be very resource- and energy-intensive. Due to the handling of solvents that are combustible, explosive, and hazardous to health and the environment at high temperatures and pressures, a high level of safety precautions may be required in order to prevent an undesirable and/or spontaneous release of solvents, mixtures, or gases. Furthermore, the porous fabrics produced by the “flash spinning” process are not very homogeneous. Since they are not formed from standard fibers like conventional nonwovens, the irregularity of the structure is relatively high.

The use of the high-density polyethylene described above can be disadvantageous with respect to sterile packaging applications because of its melting point between 115° C. and 145° C. Such a low melting point may be problematic if the material is to be sterilized at elevated temperatures. In addition, the printability of such materials with labels or the like and their ability to be heat-sealed may also be limited.

Overall, there is a continually high demand for improved materials for sterile packaging—particularly for medical applications—that overcome the aforementioned disadvantages.

### SUMMARY

In an embodiment, the present disclosure provides a packaging including a composite material. The composite material includes a barrier layer, and a backing layer. The backing layer includes a spunbonded nonwoven, arranged on at least one side of the barrier layer and bonded to the barrier layer by heat and pressure. The barrier layer includes a nonwoven containing 1 to 70 wt % melt-blown fibers and 30 to 99 wt % staple fibers, relative to a total weight of the nonwoven in each case.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an REM image of the cross-section of an exemplary barrier layer.

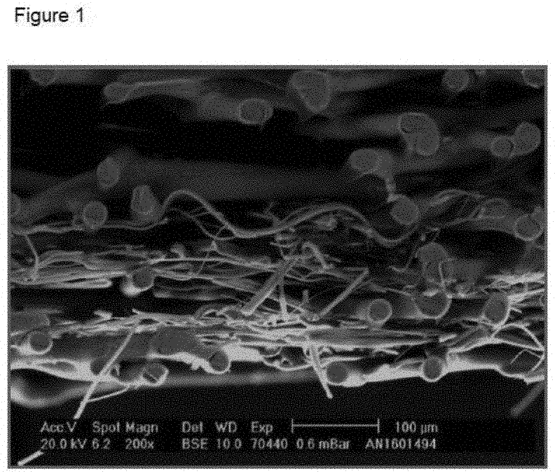

### DETAILED DESCRIPTION

Embodiments of the present invention provide packaging materials which are suitable for sterile packaging applications—particularly in the medical field. The packaging material is able to exhibit a high barrier function against germs, such as bacteria or viruses. In addition, it can be stable in standard sterilization processes, such as sterilization by high-energy radiation—particularly γ-radiation—at high temperature or pressure, and/or when treated with reactive chemicals, such as ethylene oxide. It can also exhibit high mechanical strength so that it does not have a tendency to be damaged, such as by breaking, cracking, or delamination, in the production process or during handling.

In addition, the packaging material of exemplary embodiments may be relatively uniform and, in particular, have a narrow pore-size distribution.

Furthermore, the packaging material of exemplary embodiments may exhibit high plastic deformability so that it can be used conveniently in standard packaging methods and applications.

Furthermore, the material of exemplary embodiments may be easily available by means of a standard production process. Finally, particularly for cost and environmental reasons, the packaging material of exemplary embodiments of the present invention may be lightweight and available in a simple, energy- and resource-efficient process.

These advantages can be achieved by exemplary embodiments of the present invention, such as the use of a composite material comprising:
a) a barrier layer,
b) a backing layer, comprising a spunbonded nonwoven, arranged on at least one side of the barrier layer and bonded to the barrier layer by heat and pressure,
   wherein the barrier layer comprises a nonwoven containing 1 to 70 wt % melt-blown fibers and 30 to 99 wt % staple fibers, relative to the total weight of the nonwoven in each case, as packaging material—in particular, for sterile packaging applications.

Surprisingly, it was found according to embodiments of the present invention that the aforementioned disadvantages in the prior art can be overcome with the composite material.

The composite material is thus characterized by high mechanical strength and homogeneity. As a result, damage, such as breaking, cracking, or delamination, in the production process or during handling does not occur when it is used as packaging. Furthermore, it exhibits a high barrier function against germs, such as bacteria or viruses. In addition, the composite material is stable in the sterilization processes typically used, such as, for example, sterilization by high-energy radiation—particularly, γ-radiation—by heating and/or pressure, as well as when treated with reactive chemicals, such as ethylene oxide.

In addition to the composite material's high stability, it has a high plastic deformability, so that it can be easily used in standard packaging methods and applications. The ability of the composite material to be heat-sealed is also very good.

Furthermore, the composite material is relatively easily available in an energy- and resource-saving, standard production process based upon processing the fiber polymers from the melt.

Furthermore, the composite material has the stability and barrier properties required for use as sterile packaging even at low basis weights, as a result of which, for example, it results in comparatively low costs and has a low ecological footprint during its transport.

Due to the aforementioned advantageous properties, the composite material is ideally suited as packaging material—in particular, for sterile packaging applications—preferably, though not exclusively, in the medical field.

As used herein, the term, “use of the composite material as packaging material,” refers to the composite material being used to at least partially enclose an article. With the “use for sterile packaging applications,” the composite material is used to separate the article from the environment in a sterile manner.

In preferred embodiments, the packaging material is used to completely enclose the article to be packaged. The article is preferably sealed in the composite material. There are then no holes or other openings in the packaging through which the article would still be in direct contact with the surroundings.

The composite material can be specifically configured for packaging purposes. For example, it can be manufactured by a wide variety of shaping methods or, by combination, be provided with functional means for a packaging application, such as a label. A packaging is thereby obtained.

As used herein, the term, “packaging,” thus refers to a material configured to package an article. The packaging may or may not yet contain the article to be packaged. The packaging can be adapted to the shape of the article to be packaged. It comprises the composite material and may comprise other functional means for a packaging application, such as labels or means for locking or closing. The article packaged in the packaging is referred to as a packaged article. An embodiment of the invention is therefore directed at packaging—in particular, sterile packaging—comprising a composite material as described herein.

According to exemplary embodiments of the present invention, the composite material is particularly suitable for the production of sterile packaging. In this case, “sterile” means that the composite material and/or the packaging has been sterilized, with or without the article to be packaged, using a standard sterilization method. Typically, the article is packaged in the packaging before the packaged article is sterilized. The packaged article is preferably sealed such that the article cannot be contaminated after sterilization without damaging the packaging.

According to exemplary embodiments of the present invention, the composite material comprises a barrier layer comprising a nonwoven containing 1 to 70 wt % melt-blown fibers and 30 to 99 wt % staple fibers.

The nonwoven may be produced by melt-blowing. In the field of nonwovens, the term, “melt-blowing,” refers primarily to a spinning process in which thermoplastic, fiber-forming polymers are melted in an extruder, pumped through die holes, and enter high-velocity air streams when exiting the spinnerets. The hot air streams normally exit at the sides of the nozzles, conduct the extruded polymer streams, and lead to the formation of very fine filaments. The filaments are deposited on a collector screen, whereby a relatively fine, typically self-adhesive, nonwoven web is produced. The melt-blowing process differs from conventional spunbonded technology, in which the resulting polymer fibers are not conducted by hot air streams from nozzles in the spinneret and thereby stretched, in that, normally, the filaments are first cooled by cold air before the fibers are drawn onto a conveyor belt by suction.

All synthetic polymers suitable for the melt-blowing processes known in the art can be used for the melt-blown fibers. Typically, the polymers are thermoplastic polymers that can be extruded. The melt-blown fibers typically have polymers selected from polyolefins, such as polyethylene or polypropylene, aliphatic polyesters and aromatic polyesters, such as polyethylene terephthalate, polybutylene terephthalate, polyethylene naphthalate, polycarbonate or lactate, aliphatic polyamides and aromatic polyamides, such as polyamide 6 or polyamide 6.6, halogenated polymers, such as polyvinylidene chloride or polyvinylidene fluoride, or (meth)acrylates, such as polymethyl methacrylate, mixtures or copolymers thereof. Possible copolymers are, for example, copolyesters, copolyamides, polyester polyamides, and polyolefin copolymers.

As used herein, the term, “staple fibers,” refers to discontinuous fibers having lengths of 0.5 mm to 100 mm, and thus includes short fibers in the length range of 0.5 to 20 mm. In a preferred embodiment, the composite material has staple fibers with diameters of 5 to 30 μm, and particularly preferably 10 to 20 μm. In a preferred embodiment, the composite material has staple fibers having fiber lengths of one to 60 mm, and particularly preferably 5 to 40 mm.

All synthetic polymers suitable for the production methods for staple fibers known in the art can be used for the staple fibers. Typically, the polymers are thermoplastic polymers that can be extruded. The staple fibers preferably have polymers selected from polyolefins, such as polyethylene or polypropylene, aliphatic polyesters and aromatic polyesters, such as polyethylene terephthalate, polybutylene terephthalate, polyethylene naphthalate, polycarbonate or lactate, aliphatic polyamides and aromatic polyamides, such as polyamide 6 or polyamide 6.6, halogenated polymers, such as polyvinylidene chloride or polyvinylidene fluoride, or (meth)acrylates, such as polymethyl methacrylate, mixtures or copolymers thereof. Possible copolymers are, for example, copolyesters, copolyamides, polyester polyamides, and polyolefin copolymers. It is also conceivable to use non-thermoplastic polymer fibers, such as, in particular, viscose, polyacrylonitrile or natural fibers, such as cotton or cellulose fibers.

All synthetic polymers suitable for the production methods of spunbonded nonwovens known in the art can be used to produce the spunbonded nonwoven. Typically, the polymers are thermoplastic polymers that can be extruded. According to exemplary embodiments of the present invention, the spunbonded nonwoven has spunbonded nonwoven fibers, which are also referred to here as fibers of the spunbonded nonwoven. The spunbonded nonwoven fibers preferably have polymers selected from polyolefins, such as polyethylene or polypropylene, aliphatic polyesters and aromatic polyesters, such as polyethylene terephthalate, polybutylene terephthalate, polyethylene naphthalate, polycarbonate or lactate, aliphatic polyamides and aromatic polyamides, such as polyamide 6 or polyamide 6.6, halogenated polymers, such as polyvinylidene chloride or polyvinylidene fluoride, or (meth)acrylates, such as polymethyl methacrylate, mixtures or copolymers thereof. Possible copolymers are, for example, copolyesters, copolyamides, polyester polyamides, and polyolefin copolymers.

In a preferred embodiment, the fibers, i.e., the melt-blown fibers, staple fibers, and/or the fibers of the spunbonded nonwoven, comprise at least one polymer, selected from polyesters. These materials are particularly suitable for sterile packaging applications, since they are sufficiently stable for sterilization with γ-radiation and/or at relatively high temperatures. Among the polyesters, polybutylene terephthalate and/or polyethylene terephthalate is preferred in particular. The fibers, i.e., the melt-blown fibers, staple fibers, and/or the fibers of the spunbonded nonwoven, also preferably comprise at least one polymer selected from polyolefins—in particular, polypropylene. These materials are particularly suitable, since they are likewise relatively temperature resistant.

Both the staple fibers and the spunbonded nonwoven fibers may, at least proportionally, be binder fibers. The term, “binder fibers,” is to be understood to mean that the fibers facilitate adhesive fiber bonds as a result of their thermoplastic behavior in the composite material. Typically, the binder fibers in the composite material are fused with themselves and/or other fibers. The staple fibers preferably have at least 90 wt %—preferably from 95 wt % to 100 wt %—staple binder fibers, relative to the total content of staple fibers. The spunbonded nonwoven fibers also preferably have at least 90 wt %—preferably from 95 wt % to 100 wt %—spunbonded nonwoven binder fibers, relative to the total content of spunbonded nonwoven fibers.

In a particularly preferred embodiment of the invention, the composite material comprises both spunbonded nonwoven binder fibers and staple binder fibers. In this way, a particularly good adjustment of the adhesion of the fibers or of the layers in the composite material can be achieved.

The staple binder fibers and/or the spunbonded nonwoven binder fibers may be uniform fibers or even multicomponent fibers. In a particularly preferred embodiment, the staple binder fibers and/or the spunbonded nonwoven binder fibers, independently of one another, are binder fibers with a melting point of at least one component which is below 300° C. and, in particular, is from 70to 230° C.—particularly preferably from 125to 200° C. The staple binder fibers and/or the spunbonded nonwoven binder fibers, independently of one another, preferably comprise thermoplastic polyesters and/or copolyesters—in particular, polybutylene terephthalate, polyolefins, in particular, polypropylene, polyamides, polyvinyl alcohol, or also copolymers and copolymers and mixtures thereof.

According to exemplary embodiments of the present invention, the staple binder fibers and/or the spunbonded nonwoven binder fibers, independently of one another, are particularly preferably multicomponent fibers—preferably bicomponent fibers—in particular, core/sheath fibers. Core/sheath fibers contain at least two fiber polymers with different softening and/or melting temperatures. The core/sheath fibers preferably consist of these two fiber polymers. The component which has the lower softening and/or melting temperature can be found at the fiber surface (sheath), and the component which has the higher softening and/or melting temperature can be found in the core. In a particularly preferred embodiment, both the staple binder fibers and the spunbonded nonwoven binder fibers are bicomponent fibers. More preferably, the staple binder fibers and/or the spunbonded nonwoven binder fibers, independently of one another, have a sheath with a melting point which is below 300° C. and, in particular, is from 70 to 230° C.—particularly preferably from 125 to 200° C.

In core/sheath fibers, the binding function may be executed by the materials disposed on the surface of the fibers. A very wide variety of polymers can be used for the sheath. Preferred polymers for the sheath according to the invention are polybutylene terephthalate (PBT), polyamide (PA), polyethylene (P) copolyamides, and/or also copolyesters. A very wide variety of polymers can likewise be used for the core. According to exemplary embodiments, preferred materials for the core are polyesters (PES)—in particular, polyethylene terephthalate (PET) and/or polyethylene naphthalate (PEN) and/or polyolefins (PO).

Embodiments having use of core/sheath binder fibers are preferred, since a particularly homogeneous distribution of the binder component in the nonwoven and also in the composite material can thus be achieved.

Further preferred bicomponent fibers are so-called “side-by-side” fibers. The “side-by-side” fibers contain two segments extending in the fiber direction and have fiber polymers with different softening and/or melting temperatures. In this case, the segments may be arranged uniformly or non-uniformly—for example, eccentrically. “Island-in-the-sea” fibers are also conceivable.

The core/sheath and/or “side-by-side” fibers preferably have fiber polymers that differ in their softening and/or melting temperatures by at least 5° C.—more preferably by 10° C., and, in particular, by more than 20° C.

The use of mono-component binder fibers is also conceivable, provided these can be at least partially thermally fused. Here, the choice of mono-component binder fibers depends upon the matrix fiber used. For example, polyamide 6 binder fibers are suitable for binding polyamide 6.6 matrix fibers, and copolyesters for binding polyethylene terephthalate.

In a further preferred embodiment of the invention, the melting and/or decomposition temperature of the fiber polymers of at least one fiber type, i.e., the melt-blown, staple, and/or spunbonded nonwoven fibers, is relatively high. The melting and/or decomposition temperature of the fiber polymers of the melt-blown fibers is preferably above 140° C., e.g., 160 to 400° C., preferably above 180° C., e.g., 180 to 400° C., or above 200° C., e.g., 200 to 400° C. Such a melting temperature is also advantageous for sealing the packaging, since it ensures stability of the base material—for example, in the case of thermal sealing with another material.

Also preferred is for the melting and/or decomposition temperature of the fiber polymers of at least one fiber component of the staple and/or spunbonded nonwoven binder fibers—in particular, of the core of the staple and/or spunbonded nonwoven binder fibers if they are designed as core/sheath fibers—to be above 140° C., e.g., 160 to 400° C., preferably above 180° C., e.g., 180 to 400° C., or above 200° C., e.g., 200 to 400° C. Such a melting temperature is also advantageous for sealing the packaging, since it ensures stability of the base material—for example, in the case of thermal sealing with another material.

In one embodiment of the invention, the melt-blown fibers and the staple fibers of the barrier layer are distributed uniformly in the nonwoven.

The melt-blown fibers in the composite material according to exemplary embodiments of the present invention preferably comprise at least 60 wt %, e.g., 60 to 100 wt %—more preferably at least 70 wt %, e.g., 70 to 100 wt %—relative in each case to the total weight of the melt-blown fibers, a fiber diameter of 0.1 to 50 μm, more preferably 0.3 to 30 μm, and in particular 0.5 to 10 μm.

The staple fibers in the composite material according to exemplary embodiments of the present invention preferably have average fiber diameters of 5 to 50 μm—more preferably 7 to 20 μm. However, it may also contain fibers with smaller fiber diameters, e.g., nano-cellulose with fiber diameters of less than 100 nm. In addition, staple fibers with fiber diameters of more than 50 μm are also possible. The spunbonded nonwoven fibers in the composite material according to exemplary embodiments of the present invention preferably have average fiber diameters of 5 to 100 μm, and, particularly preferably, 10 to 50 μm.

In preferred embodiments, the barrier layer is produced by depositing the staple fibers together with the melt-blown fibers.

This is advantageous, since a particularly high homogeneity is thereby imparted to the barrier layer as a result. In this case, the staple fibers and the melt-blown fibers are preferably deposited on the backing layer. This is advantageous, since a particularly close contact, and thus also a particularly good bonding of the layers, is thereby facilitated. The barrier layer is particularly preferably produced by blowing the staple fibers into the melt-blown stream, which is deposited on the backing layer.

According to exemplary embodiments of the present invention, the barrier layer and the backing layer are preferably bonded to one another by heat and pressure. As is known in the art, such thermal bonding can be carried out in such a way that the basic fiber structure of the two layers is at least partially maintained. In this case, only enough thermal energy for the fibers to soften but not completely melt is introduced, wherein binding sites are produced in the entire composite material.

According to exemplary embodiments of the present invention, the composite material is preferably produced by a method comprising the following method steps:
a) production of a barrier layer comprising a nonwoven containing 1 to 70 wt % melt-blown fibers and 30 to 99 wt % staple fibers,
b) arrangement of at least one backing layer, comprising a spunbonded nonwoven, on at least one side of the barrier layer,
c) bonding of the barrier layer and the backing layer by means of heat and pressure.

In a preferred embodiment, the thermal bonding is carried out by calendering. In this standard method, a nonwoven is passed through a pair of calender rollers, which are typically heated. The conditions of the calendering step are preferably configured in such a way that only partial melting of the fibers takes place, so that the nonwoven is thermally bonded to a desired extent. The amount of adhesion and adhesive force can be adjusted, for example, by changing the speed of the calender rollers, the pressure, the distance between the roller gaps, and the temperature. This allows a degree of thermal bonding to be obtained in such a way that a desired mechanical strength is achieved, as a result of which the basic fiber structure—in particular, in the core of the nonwoven—can, for the most part, be attained or at least maintained to a desired degree. For example, the bonding of barrier layer and backing layer may be calendered with a pair of calender rollers having one or more of the following settings:
a) a roller speed of between 1 and 200 m/min, and preferably between 50 and 180 m/min,
b) a line pressure on the rollers of between 1 and 1,000 N/mm bar, and preferably between 50 and 500 N/mm bar,
c) a distance between the roller gaps of between 0.01 mm and 5 mm, and preferably between 0.001 mm and 3 mm,
d) a roller temperature of between 10° C. and 400° C., and preferably between 150° C. and 280° C.

Calendering may take place over the entire surface of the barrier layer and/or backing layer or parts thereof if the roller surface is patterned. According to exemplary embodiments, calendering is preferred for thermal bonding, since the mechanical strength of the nonwoven and of the entire composite material can be increased, while the fiber structure of the nonwoven is substantially maintained.

In a preferred embodiment, the basis weight of the composite material is between 10 g/m² and 200 g/m². The basis weight is preferably between 20 and 140 g/m², and more preferably between 50 g/m² and 120 g/m². The basis weight is preferably not higher than 200 g/m², preferably not higher than 140 g/m², and in particular not higher than 120 g/m² or even 100 g/m². The basis weight is preferably at least 10 g/m² or at least 20 g/m², or, in a certain embodiment, at least 50 g/m². According to the invention, the basis weight is measured according to DIN ISO 9073-1 (1989). The basis weight is preferably adjusted in such a way that the packaging has the mechanical strength and barrier function required in each case.

In a preferred embodiment, the tensile strength of the composite material in the machine- and transverse-directions is at least 100 N/5 cm. The tensile strength is preferably at least 125 N/5 cm, and preferably at least 150 N/5 cm. The tensile strength is preferably in the range of 100 N/5 cm to 600 N/5 cm, and specifically in the range of 150 N/5 cm to 500 N/5 cm. The tensile strength is determined according to ISO 1924-2 (2009). The tensile strength is also an indicator of the suitability as packaging—especially for sterile medical packaging. The high tensile strength shows that the material is suitable for sterilization and typical packaging applications.

In a preferred embodiment, the elongation of the composite material in the machine- and transverse-directions is at least 5%. The elongation is preferably at least 10%, and more preferably at least 20%. The elongation is preferably in the range of 5% to 50%, more preferably between 10% and 40%, and most preferably between 20% and 30%. The elongation is determined according to ISO 1924-2 (2009). Such an elongation is advantageous, since the nonwoven has sufficient flexibility, as well as elastic and plastic deformability, required for standard packaging applications. The flexibility gives the packaging material additional stability and reduces the risk of damage—for example, by puncturing. According to exemplary embodiments, it is particularly advantageous that the high flexibility can be achieved even though the mechanical strength is high and the air permeability is high. According to the prior art, e.g., in the case of flash-spun porous plates for medical applications, it is difficult to combine high air permeability with high mechanical strength and flexibility. Typically, porous plates used in the prior art have relatively low flexibility, as indicated by the elongation.

In a preferred embodiment, the tear resistance of the composite material in machine- and transverse-directions is at least 1 N. The tear resistance is preferably at least 1.5 N, and preferably at least 2 N. The tear resistance is preferably in the range of 1 N cm to 5 N, and specifically in the range of 2 N to 4 N. The tear resistance is determined according to EN21974 (1994).

In a preferred embodiment, the thickness of the composite material in the machine- and transverse-directions is at least 50 μm. The thickness is preferably at least 100 μm, and preferably at least 150 μm. The thickness is preferably in the range of 100 μm to 500 μm, and specifically in the range of 150 μm to 300 μm. The thickness is determined according to EN ISO 534 (2012).

In a preferred embodiment, the puncture resistance of the composite material in the machine- and transverse-directions is at least 5,000 J/m². The puncture resistance is preferably at least 6,000 J/m², and preferably at least 7,000 J/m². The puncture resistance is preferably in the range of 2,000 J/m²to 10,000 J/m², and specifically in the range of 6,000 J/m²to 9,000 J/m². The puncture resistance is determined in accordance with ASTM D3420 (1994).

In a preferred embodiment, the average pore size of the composite material measured in accordance with DIN ASTM E1294 (1999) is at least 0.5 μm, and preferably at least 1 μm. The average pore size is preferably in the range of 1 μm to 15 μm, and specifically in the range of 2 μm to 10 μm. If the average pore size is below 0.5 μm, poorer degrees of sterilization are generally achieved, and, if the average pore size is more than 20 μm, the probability of bacteria/viruses passing through is too great.

The burst resistance of the composite material, measured according to ISO 2758 (2014), is preferably at least 200 kPa, preferably at least 500 kPa, and more preferably at least 700 kPa. The burst resistance of the composite material may be below 2,000 kPa or below 1,500 kPa. The burst resistance is preferably in the range of 200 kPa to 2,000 kPa, and preferably 300 kPa to 1,500 kPa or 500 kPa to 1,500 kPa. It has been found that the packaging according to the invention has a high burst resistance. Burst resistance is an indicator of the mechanical stability under pressure of a of a material suitable for packaging applications. High burst resistance is required for sterilization applications under vacuum. In sterilization applications, packaging may be subjected to pressure during the injection of sterilization gases, followed by the removal of the gases. The high burst resistance of the inventive composite material indicates that it is suitable for such standard sterilization methods.

In a preferred embodiment, the air permeability of the composite material is at least 200 mL/min. The air permeability is preferably at least 300 mL/min, and more preferably at least 400 mL/min. In particular, the air permeability is in the range of 200 mL/min to 1,000 mL/min, or specifically in the range of 300 mL/min to 800 mL/min. The air permeability is preferably determined according to ISO 5636-3 (2013; Bendtsen test). High air permeability is required, in particular, in standard sterilization processes in which packaging is sterilized with gaseous chemicals or steam. In such a process, e.g., using ethylene oxide, the packaging is sealed, and the packaged article is subjected to a sterilization treatment in which the sterilizing agent penetrates into the packaging. It has been found that the composite material used according to the invention has sufficient permeability for such sterilization methods.

In a preferred embodiment, the composite material is printable. It may, therefore, be marked with labels, tags, or the like in a simple printing process.

In a preferred embodiment, the composite material is stable at relatively high temperatures. The packaging is preferably stable at temperatures of up to 140° C., and preferably up to 200° C. or even up to 220° C. This means that the structure is not especially disturbed and the polymers are not melted at such a temperature. Such thermostable composite materials may be sterilized at high temperatures, which is highly advantageous for various sterilization applications.

Exemplary embodiments of the present invention also provide a packaging—in particular, a sterile packaging—comprising a composite material as described herein. The preferred embodiments described with reference to the inventive use are also preferred embodiments of the inventive packaging.

In a preferred embodiment, a packaging obtained from the composite material is and/or will be sterilized by γ-radiation (gamma radiation). This process is also referred to as γ-ray sterilization. Gamma rays are high energy and are known to chemically modify or destroy substrates with low mechanical strength. However, the packaging may be provided with high mechanical strength so that it can be subjected to efficient sterilization by γ-radiation.

In a preferred embodiment, the packaging is a medical packaging. The term, “medical packaging,” refers to all sterile packaging specifically required in the technical field of pharmaceuticals and health. For example, a medical packaging may comprise a packaged article which is a pharmaceutical composition, such as a medicinal product or a liquid, or a medical device, such as a catheter, a syringe, a wound dressing, or the like. There is a high demand in medical packaging for secure and cost-efficient sterile packaging material, since all relevant devices and pharmaceutical compositions must, in principle, be provided and maintained in sterile form. Moreover, there is a high demand for light, simple packaging in the medical field. The packaging according to exemplary embodiments is ideally suited to such requirements, since it combines various advantageous properties such as high mechanical strength, high barrier function due to low porosity, good air permeability, low weight, and relatively simple production. In particular, the material is strong enough for standard sterilization by γ-radiation, steam, or chemicals.

Exemplary embodiments of the present invention also provide a packaged article packaged using a composite material as described herein. Exemplary embodiments also include the use of the composite material described herein for packaging an article. Preferably, the article is a medical article, and the composite material is embodied as medical packaging. In another embodiment, the article is a cosmetic article, and the packaging is a cosmetic packaging. Preferably, the article is a sterile article, and the packaging is a sterile packaging.

In principle, the inventive use applies to the packaging of all articles—in particular, of a medical article which is packaged with the composite material and subsequently sterilized. The packaged medical article may be a composition or a device. For example, the composition could be a pharmaceutical composition, such as a medicinal product, or another solid or liquid agent, or a composition that is used in the medical field. The device may be a disposable article, such as a syringe or a wound dressing. The medical article is preferably used in a medical treatment, such as therapy, diagnosis, or surgery.

Exemplary embodiments of the present invention also provide a method for providing a packaged article, comprising:
a) provision of the article and of a composite material, comprising
a barrier layer,
a backing layer, comprising a spunbonded nonwoven, arranged on at least one side of the barrier layer and bonded to the barrier layer by heat and pressure, wherein the barrier layer comprises a nonwoven containing 1 to 70 wt % melt-blown fibers and 30 to 99 wt % staple fibers, relative in each case to the total weight of the nonwoven,
b) packaging the article in the composite material, and
c) optionally sterilizing the packaged article.

The method is also a method for providing a packaged article. Preferably, the packaged article is a medical article as described above. The method is also a method for sterilizing a packaged article, if step (c) is applied. The packaging in step (b) is preferably carried out in such a way that the article is sealed, i.e., is completely shielded from the environment by the packaging.

In a preferred embodiment, before step (a), the method comprises the steps of

(a1) producing the backing layer in a spunbonded process and producing the barrier layer in a melt-blown process with simultaneous deposition of the staple fibers with the melt-blown fibers, and
(a2) thermally bonding the barrier layer to the backing layer on at least one side of the barrier layer in order to obtain the composite material.

The staple fibers and the melt-blown fibers are preferably mixed together in step (a1) by blowing the staple fibers into a melt-blown fiber stream.

After step (a2), the composite material may be transformed into the packaging by further steps—for example, by applying a label. In a preferred embodiment, steps (a1) through (b), and optionally with additional step (c), are carried out successively in a single process. Alternatively, a composite material may be obtained after steps (a1) and (a2), while the packaging of an article happens separately, e.g., by a supplier of medical articles.

The preferred embodiments described with reference to the inventive use are also preferred embodiments of the inventive method.

The inventive uses, packaging, and methods solve the problems underlying the invention. The composite material is suitable for the sterile packaging of articles, such as medical articles. The composite material has high mechanical strength and a high barrier function against germs, such as bacteria or viruses. The composite material has sufficient stability, which is suitable for standard sterilization processes, such as γ-radiation, high-temperature treatment, or chemical sterilization. It has sufficient porosity for sterilization treatment using chemicals. Its mechanical strength and high elastic and plastic deformability are particularly advantageous for standard packaging methods and applications. All advantageous properties can be achieved with a product having a relatively low basis weight. Overall, the composite material is suitable for simple and efficient packaging of articles.

### EXAMPLES

The composite materials according to exemplary embodiments of the present invention were produced as described below.

### Example 1

PET/CoPET Bico stack binder fibers:

### Length—38 mm

Fineness—2.2 dTex

### CoPET (m.p.)—180° C.

### Melt-blown PET:

Fiber diameter—0.3 to 2 μm
Spunbonded nonwoven binder fibers PET/CoPET:
Fiber diameter—7 to 30 μm

### CoPET (m.p.)—180° C.

The homogeneously-carded PET/CoPET Bico staple fibers are constantly injected into the melt-blown stream via a tertiary air duct (TAC). The fibers mix with the melt-blown PET fiber stream and are deposited on the spunbonded nonwoven by suction. The resulting nonwoven is then compressed by a pair of calender rollers, whereby a homogeneously-shaped composite material, which is suitable for sterilization due to the high temperature stability, is produced. The use of the melt-blown fibers means that the composite material has relatively small pore sizes, which leads to a good barrier effect against viruses and bacteria. Nevertheless, the composite material exhibits sufficient air permeability, which is important for sterilization.

### Example 2

PET/CoPET Bico staple fiber:

### Length—32 mm

Fineness—1.7 dTex

### CoPET (m.p.)—180° C.

### Melt-blown PET:

Fiber diameter—0.3 to 3 μm
Spunbonded nonwoven PET/CoPET:
Fiber diameter—7 to 30 μm

### CoPET (m.p.)—180° C.

The homogeneously-carded PET/CoPET Bico staple fibers are constantly injected into the melt-blown stream via a tertiary air duct (TAC). The fibers mix with the melt-blown PET fiber stream and are deposited on the spun-bonded nonwoven by suction. The resulting nonwoven is then compressed by a pair of calender rollers, whereby a homogeneously-shaped composite material, which is suitable for sterilization due to the high temperature stability, is produced. The use of the melt-blown fibers means that the composite material has relatively small pore sizes, which leads to a good barrier effect against viruses and bacteria. Nevertheless, the composite material exhibits sufficient air permeability, which is important for sterilization.

### Measuring Methods

The basis weight is defined as the mass per unit area and is measured in grams per square meter (g/m²). The basis weight of nonwovens is measured according to the ISO 9073-1 (1989) standard.

The thickness of nonwovens is measured in um according to the EN ISO 534 (2012) standard.

Measurements of nonwoven pore sizes were carried out using a Porous Materials, Inc. (PMI) tester (Porous Materials, Inc., US). The ASTM E 1294 (1989) standard was complied with for measuring the pore size of sterile packaging products. The pore-size measurements were based upon the displacement of wetting liquid with low surface tension (trademark GALDEN HT 230; Solvay, IT) from a pore by a gas.

Tensile strength (breaking strength) and elongation of nonwovens were measured using a tensile strength tester according to ISO 1924-2 (2009). In order to measure the tensile strength and elongation of the nonwoven, five strips were cut from machine- and transverse-directions (MD & CD) at different points of the sample. The cut samples were stretched onto the clamps of the tensile tester and pulled at a constant stretching speed. The tensile strength and elongation were then recorded and averaged for each sample.

The air permeability of nonwovens was measured according to the ISO 5636-3 standard (2013; Bendtsen test).

The tear resistance of nonwovens was determined in accordance with European standard EN21974 (1994).

The burst strength of nonwovens was measured using the burst pressure measuring device according to the ISO 2758 (2014) standard.

The puncture resistance of nonwovens is measured according to the ASTM D3420 (1994) standard.

The measurement results for Examples 1 & 2 according to the invention are summarized in the following table and are compared with the commercial product (Tyvek®).

| | | | | Example | Example |
|---|---|---|---|---|---|
| Properties | Unit | Standard | Tyvek ® | 1 | 2 |
| Basis weight | g/m2 | EN ISO 536 | 80 | 75 | 85 |
| | | (Tyvek) DIN | | | |
| | | ISO 9073-1 | | | |
| Thickness | μm | EN ISO 534 | 171 | 162 | 184 |
| Polymer | | | HDPE | PET | PET |
| Thermal | ° C. | DIN ISO | up to | up to | up to |
| stability | | 11357-3 (2013) | 125° C. | 250° C. | 250° C. |
| Tensile | N/5 cm | ISO 1924-2 | 174 | 162 | 182 |
| strength | | | | | |
| Elongation | % | | 22 | 21 | 20 |
| Pore-size | μm | ASTM E1294 | 2-8 | 1-10 | 1-10 |
| distribution | | | | | |
| Tear | N | EN 21974 | 3.1 | 2.9 | 3.2 |
| resistance | | | | | |
| Puncture | J/m² | ASTM D3420 | 8,354 | 7,974 | 8,471 |
| resistance | | | | | |
| Burst | kPa | ISO 2758 | 1,199 | 1,241 | 1,331 |
| resistance | | | | | |
| Air | mL/min | ISO 5636-3 | 542 | 579 | 514 |
| permeability | | | | | |

It is found that the composite materials according to embodiments of the invention have higher thermal stability than the comparative material, with comparatively good mechanical properties and pore-size distribution. Due to the use of PET material, the composite material according to embodiments of the present invention can be well sterilized and welded. In contrast, the layer adhesion and the printability of the comparative product are worse.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A packaging comprising a composite material, the composite material comprising:
(a) a barrier layer, and
(b) a backing layer, comprising a spunbonded nonwoven, arranged on at least one side of the barrier layer and bonded to the barrier layer by heat and pressure, wherein the barrier layer comprises a nonwoven containing 1 to 70 wt % melt-blown fibers and 30 to 99 wt % staple fibers, relative to a total weight of the nonwoven in each case.

2. The packaging according to claim 1, wherein the melt-blown fibers, the staple fibers, and/or fibers of the spunbonded nonwoven have at least one polymer, selected from polyesters, and/or polyolefins.

3. The packaging according to claim 1, wherein the staple fibers are, at least proportionally, staple binder fibers, and the fibers of the spunbonded nonwoven are, at least proportionally, spunbonded nonwoven binder fibers, wherein the composite material preferably has both spunbonded nonwoven binder fibers and staple binder fibers.

4. The packaging according to claim 3, wherein the staple binder fibers and/or the spunbonded nonwoven binder fibers, independently of one another, are bicomponent fibers.

5. The packaging according to claim 4, wherein the bicomponent fibers are core/sheath fibers.

6. The packaging according to claim 1, wherein the barrier layer is produced by depositing the staple fibers together with the melt-blown fibers.

7. The packaging according to claim 1, wherein the barrier layer is produced by blowing the staple fibers into a melt-blown stream which is deposited on the backing layer.

8. The packaging according to claim 1, wherein a basis weight of the composite material is between 10 g/m² and 200 g/m².

9. The packaging according to claim 1, wherein a thickness of the composite material in a machine-direction and a transverse-direction is at least 50 μm.

10. The packaging according to claim 1, wherein an average pore size of the composite material measured in accordance with DIN ASTM E1294 (1999) is in the range of 1 μm to 15 μm.

11. The packaging according to claim 1, wherein an air permeability of the composite material is at least 200 mL/min.

12. The packaging according to claim 1, wherein the composite material is configured as medical packaging, and the composite material is used for packaging a medical article.

13. The packaging according to claim 1, wherein the packaging material is a sterile packaging material.

14. A method for providing a packaged article, comprising:
(a) provision of an article and of a composite material, the composite material comprising:
a barrier layer, and
a backing layer, comprising a spunbonded nonwoven, arranged on at least one side of the barrier layer and bonded to the barrier layer by heat and pressure, wherein the barrier layer comprises a nonwoven containing 1 to 70 wt % melt-blown fibers and 30 to 99 wt % staple fibers, relative in each case to a total weight of the nonwoven; and
(b) packaging the article in the composite material to form a packaged article.

15. The method according to claim 14, further comprising:
(c) sterilizing the packaged article.
